(19) United States
(12) Patent Application Publication
(10) Pub. No.: US 2023/0288552 A1
(43) Pub. Date: Sep. 14, 2023

(54) METHODS AND WIRELESS COMMUNICATION DEVICES FOR ESTIMATING A DISTANCE BETWEEN A FIRST AND A SECOND WIRELESS COMMUNICATION DEVICE

(71) Applicant: Sony Group Corporation, Tokyo (JP)

(72) Inventors: Martin Warwick BEALE, Basingstoke (GB); Kazuyuki SHIMEZAWA, Basingstoke (GB); Shin Horng WONG, Basingstoke (GB)

(73) Assignee: Sony Group Corporation, Tokyo (JP)

(21) Appl. No.: 18/017,859

(22) PCT Filed: Aug. 3, 2021
(86) PCT No.: PCT/EP2021/071659

§ 371 Date: Jan. 25, 2023

(30) Foreign Application Priority Data
Aug. 4, 2020 (EP) 20189491.2

(51) Int. Cl. G01S 13/76; H04W 64/00

(52) U.S. Cl. CPC G01S 13/765; H04W 64/00

(57) ABSTRACT

A method for estimating a distance between first and second wireless devices, the method comprising while operating in a first mode of operation, receiving by the second wireless device a first type signal as a beacon signal requesting the second wireless device to transmit a second type signal, the beacon signal transmitted by the first wireless device, in response to receiving the beacon signal, the second wireless device transmitting the second type signal, the second type signal being a first synchronisation signal and indicating that the first wireless device is to transmit a second synchronisation signal, determining a first time at which the first synchronisation signal is transmitted, and operating in a second mode of operation in which the first device monitors for a second type signal transmitted by the first wireless device in response to the first synchronisation signal.

### BACKGROUND

### Field

The present disclosure relates to communications devices, infrastructure equipment and methods for the determination of a distance between wireless communications devices.

The present application claims the Paris convention priority to European patent application number 20189491.2 the contents of which are incorporated herein by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”.

There are many applications and use cases where it is desirable to be able to determine a distance between two communications devices. Although current wireless communications networks can provide location services which allow an absolute location (e.g. latitude, longitude, elevation) of a communications device to be determined, these have several disadvantages, and there thus arises a challenge to provide an efficient determination of proximity between communications devices which needs to be addressed.

### SUMMARY

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications devices which may be configured in accordance with example embodiments;

FIG. 4A and FIG. 4B illustrate the principles of location estimation using OTDOA in accordance with conventional techniques;

FIG. 5 illustrates the determination of a distance estimation between a first device and a second device in accordance with embodiments of the present technique;

FIG. 6 illustrates the transmission of a plurality of pairs of synchronisation signals, and a ‘stop’ synchronisation signal, in accordance with embodiments of the present technique;

FIG. 7A and FIG. 7B illustrate an example of multiple synchronisation signals being sampled at different relative times in accordance with embodiments of the present technique;

FIG. 8 illustrates an example embodiment in which the duration ΔT2, corresponding to a duration between the reception by a first device of a first synchronisation signal and the transmission of a corresponding second synchronisation signal, is selected from a plurality of predetermined values, in accordance with embodiments of the present technique;

FIG. 9 illustrates a use of multiple pairs of synchronisation signals in accordance with embodiments of the present technique;

FIG. 10 illustrates the transmission of a sequence of synchronisation signals where the time between the reception of an nth synchronisation signal and the transmission of an (n+1)th subsequent synchronisation signal varies, in accordance with embodiments of the present technique;

FIG. 11 illustrates the transmission of response signals after the transmission of synchronisation signals, in accordance with embodiments of the present technique.

### DETAILED DESCRIPTION OF THE EMBODIMENTS

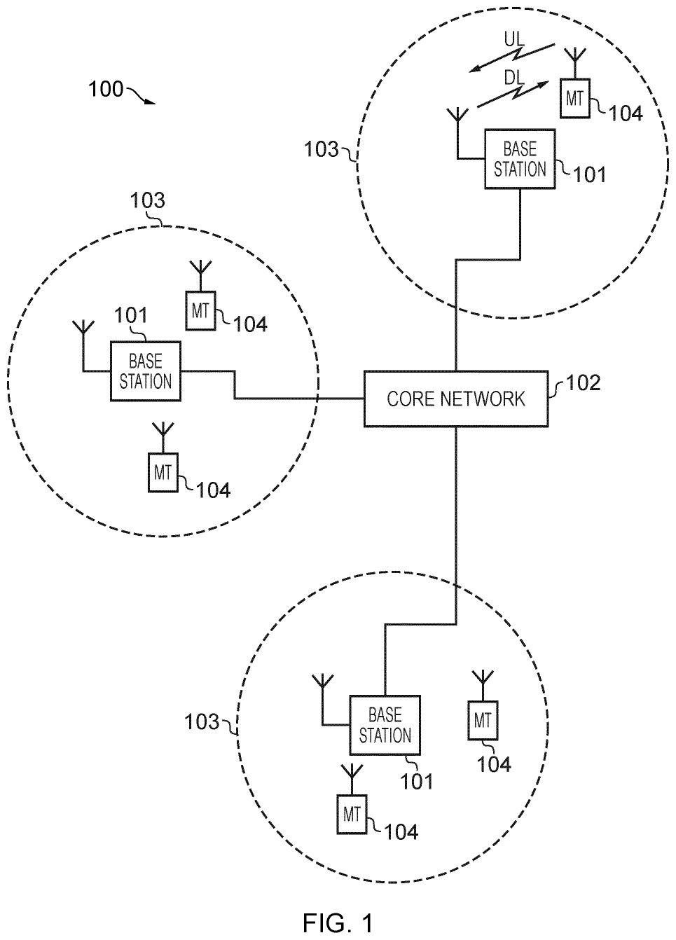

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

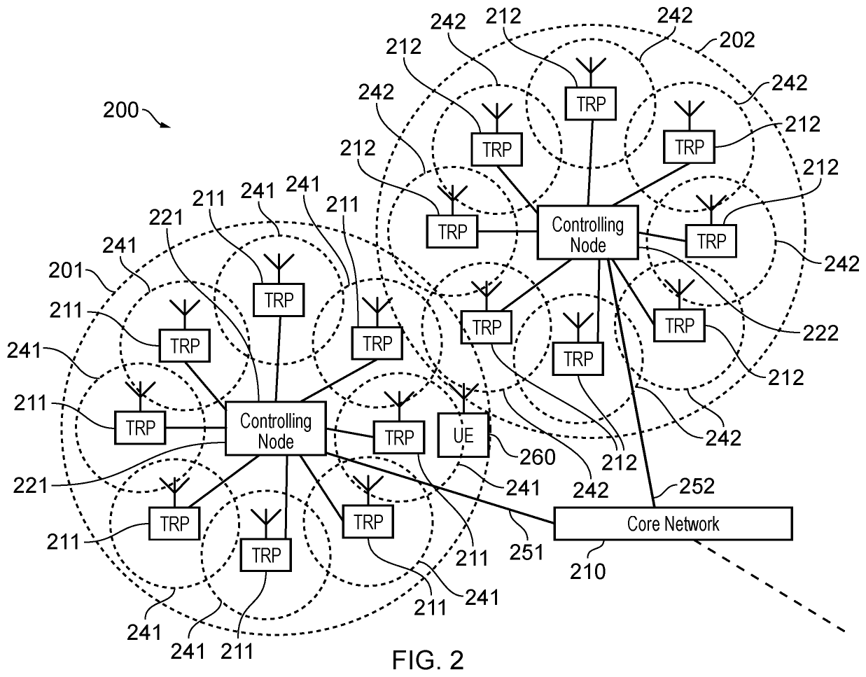

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

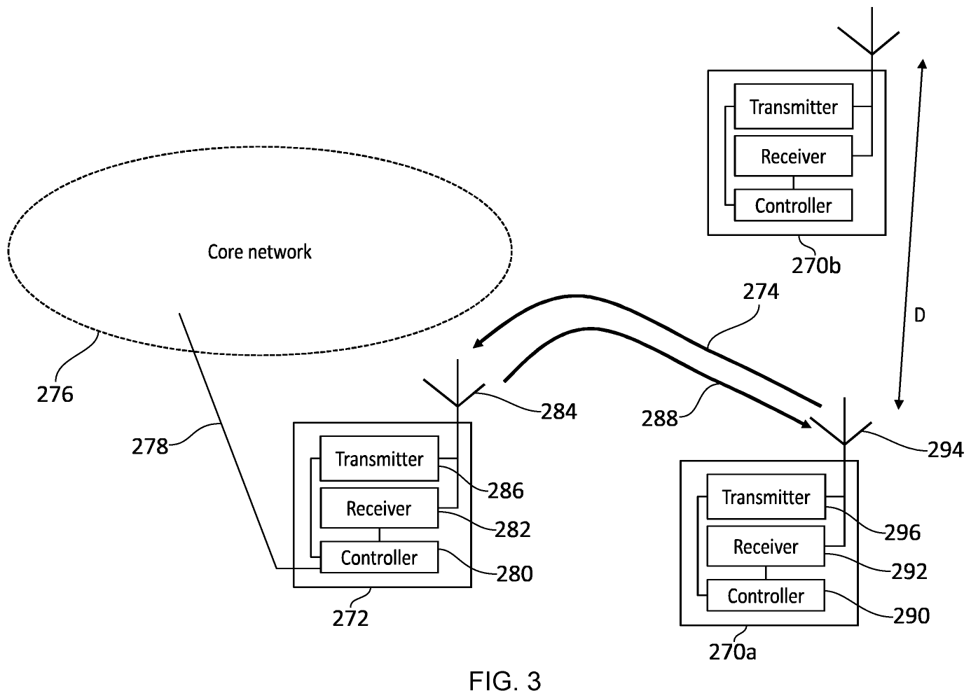

FIG. 3 illustrates a more detailed illustration of a first communications device 270a and an example network infrastructure equipment 272, which may be thought of as a base station 101 or a combination of a controlling node 221 and TRP 211. As shown in FIG. 3, the first communications device 270a is shown to transmit uplink data to the infrastructure equipment 272 of a wireless access interface as illustrated generally by an arrow 274. The first communications device 270a is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the first communications device 270a includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the first communications device 270a is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the first communications device 270a will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

FIG. 3 also shows a second communications device 270b which may be physically proximate to the first communications device 270a, separated from the first device 270a by a distance D, and may be configured in accordance with embodiments of the disclosure as described herein.

The second communications device 270b may be configured in a similar way and have similar functionality to the first communications device 270a.

In the example of FIG. 3, as described above, the first communications device 270a is configured to communicate with the infrastructure equipment 272. In some embodiments, the second communications device 270b is also configured to communicate with the infrastructure equipment 272. In some embodiments, the second communications device 270b is configured to communicate with a second infrastructure equipment (not shown in FIG. 3), whereby the first and second infrastructure equipment form parts of different wireless communications networks.

In some embodiments, one or both of the first and second communications device 270a, 270b are not within a communication range of an infrastructure equipment with which they are configured to communicate. In some further embodiments, one or both of the first and second communications device 270a, 270b are not configured to communicate with an infrastructure equipment of a wireless communications network.

There are many applications and use cases where it would be beneficial to be able to efficiently determine an estimate of the physical separation D of the first and second devices 270a, 270b and/or to detect that first communications device 270a is in proximity of the second communications device 270b (for example, to detect that the separation D is below a predetermined threshold).

Examples, in which the presently-disclosed techniques may be used, include:
Games and recreation: sports (e.g. rugby) may be played according to rules whereby a player is penalised if coming within a certain distance of an opposing player. The nature of the penalty may depend on the proximity (distance) between the players. For example, in a game of non-contact rugby, if a player gets within 1-2 m of an opponent, the opponent is required to give up possession of the ball. If the player gets close to actual contact (e.g. within 0-1 m), a penalty is awarded.

In a geocaching or treasure hunt activity, if a participant gets within a specified distance of the geocache/“treasure”, the geocache/treasure is considered to be “found”.
Retail: A shop can monitor how many people are looking at a shop window.
“Smart” city: At a pedestrian road crossing, it may be automatically determined how many pedestrians are waiting at the crossing for permission to cross a road.
Restricted/dangerous areas: Proximity to a dangerous cliff edge could trigger a warning to a user; similarly, a user could be automatically alerted if they come close to a waste site at which hazardous materials are stored.
Public safety: A user could be automatically alerted when they are approaching a prohibited/restricted zone associated with a public safety incident. In another application, where an individual is placed under restrictions (e.g. on release from custody) preventing them from contacting certain other people, this could be enforced based on proximity detection in respect of a tag attached to that individual.
Item location: A user is informed when their device is in proximity to an item which they are trying to locate. Preferably, an indication is provided to the user of their current distance from the item.
Personal contact tracing. In a public health application, it can be determined which other people someone has been in proximity to, and for how long. This can be used for controlling outbreaks of infectious diseases.

Thus, referring to the example of FIG. 3, there are numerous applications and use cases where an efficient means to determine whether the first and second communications device 270a, 270b are in proximity to each other, and (in some cases) to estimate a distance between them, would be beneficial.

Existing techniques can provide for the determination of an absolute location of a communications device which is configured to communicate with a wireless communications network. In the present disclosure, an absolute location is one where the location is determined relative to a fixed frame of reference. For example, a longitude/latitude pair may constitute an absolute location for a device constrained (or assumed) to be at ground level. Other examples of absolute locations may be represented by a grid reference or a unique address or postal code.

Current 3GPP specifications define functionality for identifying an absolute location of a UE or communications device which is configured to operate in accordance with those specifications, and in communications with a wireless communications network operating according to those specifications. There are various positioning techniques that are specified, including:
Observed time difference of arrival (OTDOA), whereby the timing of signals from various base stations/infrastructure equipment is measured at the communications device, and the location of the communications device is determined based on triangulation using these timing measurements. This is described in further detail below.
Uplink time difference of arrival (UTDOA), in which the timing of signals transmitted by the communications device is measured by different infrastructure equipment (gNBs) and the network performs triangulation to determine communications device (UE) position.
Cell ID. The location of the UE is determined as being within a region defined by a coverage region corresponding to its current serving cell.
Enhanced Cell ID. In addition to its current serving cell, the location of the UE is determined based on other measurements within the cell to make an estimate of which area of the cell that the UE is located in. For example, by measuring received signal strength (or reference signal received power, RSRP) of signals transmitted by the communications device, the network may estimate a distance of the UE from the infrastructure equipment providing the serving cell, based on an assumed pathloss model.
Assisted GPS (global positioning system). The location of the UE can be determined using conventional GPS, which may be enhanced by the provision of GPS assistance information to the UE, including satellite ephemeris and almanac information. Other satellite-based location systems can also be used instead of, or as well as, GPS.
Multi-round trip time (RTT). This technique uses measurements of a round-trip time between the communications device and multiple infrastructure equipment and is further described below.

Observed Time Difference of Arrival (OTDOA)

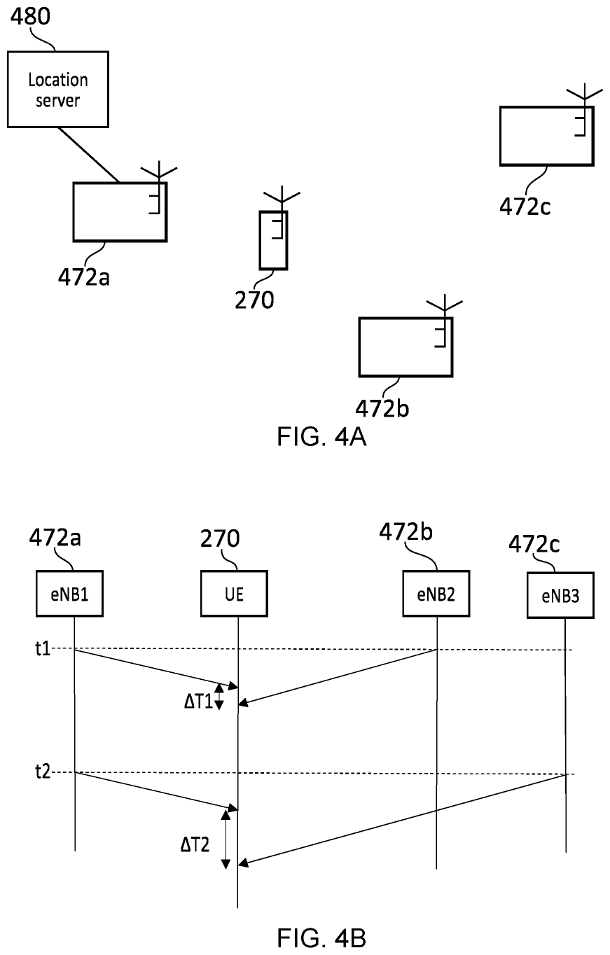

FIG. 4A and FIG. 4B illustrate the principles of location estimation using OTDOA in accordance with conventional techniques.

FIG. 4A and FIG. 4B show three base stations, or infrastructure equipment 472a, 472b, 472c, which may broadly correspond to the base stations 101 of FIG. 1, the TRPs 211, 212 of FIG. 2 or the infrastructure equipment 272 of FIG. 3. The first base station 472a is the serving base station for the communications device 270.

As shown in FIG. 4B, the communications device 270 measures a first time difference ΔT1, which is the difference of arrival times of signals transmitted at time t1 from the first and second base stations 472a, 472b. The communications device 270 also measures a second time difference ΔT2 which is the difference of arrival times of signals transmitted at time t2 from the first and third base stations 472a, 472c. For clarity, t1 and t2 are shown as different in the example of FIG. 4B, but they may be the same. The signals may be reference signals, such as a conventional LTE primary synchronisation signal (PSS) or secondary synchronisation signal (SSS). The signals may be specifically for the purpose of location measurements, such as conventional positioning reference signals (PRS) specified in 3GPP Release 9.

The first and second time differences ΔT1, ΔT2 are reported via the serving base station 472a to a location server 480 which knows the actual location of the three base stations 472a, 472b, 472c and is thus able to determine, based on the first and second time differences ΔT1, ΔT2, the location of the communications device 270.

For greater accuracy, corresponding measurements may be taken of the time difference of arrival of further signals from additional base stations.

It will be appreciated that the signals transmitted by the base stations need not be simultaneous, if any offset in their transmission times is known.

Challenges with OTDOA include the following:
accuracy may be limited, depending on the nature of signals measured, the number of base stations whose signals are measured and their relative location;
availability is restricted to locations where a 3GPP network supporting the feature is available, and where signals from at least three base stations (whose location is known to the location server) can be received and measured;
the communications device may be required to have permission to connect to the wireless communications network associated with the first base station 472a; in practice, this may require a subscription to that network.

Multi-Round Trip Time Positioning

Future communications networks based on the 3GPP new radio (NR) standard may provide location services based on measurements of a round-trip time (RTT) for signals transmitted between the communications device and multiple infrastructure equipment of a wireless communications network.

The Multi-RTT positioning method (see [4]) makes use of UE receive-to-transmit (Rx-Tx) time difference measurements and, optionally, received signal strength (RSRP) measurement of downlink PRS signals received from multiple TRPs (such as the TRPs 212, 222 of FIG. 2) by the UE. Multiple TRPs measure Rx-Tx time differences and, optionally, received signal strength (RSRP) measurement of uplink sounding reference signals (SRS) transmitted by the UE.

The measurements are used to determine the round-trip time (RTT) for transmissions between the UE and each TRP. Based on the determined RTTs, a positioning server can estimate the location of the UE.

This solution also suffers from the problems identified above with respect to the OTDOA technique.

Ranging Techniques

In general, conventional techniques which determine the absolute location of a communications device may be particularly unsuitable for applications where it is desired to determine when any two devices are in proximity (such as in a public health application) or when it is desired to identify all devices which a specified device comes close to over a period of time. This is because, in order to identify such devices (or pairs of devices) it is necessary to continually determine the location of all devices, and calculate the separation between all possible pairs of devices.

Some conventional techniques can mitigate this by providing an estimate of a distance between two devices based on measurements by one device of a signal strength of signals transmitted by another device.

For example, a process for ranging using Bluetooth signals can comprise a first device measuring a received signal strength indicator (RSSI) associated with Bluetooth signals transmitted by another device. With knowledge of the transmit power used for these signals and an assumed pathloss model, an estimation of the separation distance between the devices can be obtained, without any dependence on network infrastructure equipment (see e.g. [3]).

However, range determination using this technique can suffer from poor accuracy. The assumed pathloss model may be inappropriate: for example, the free space pathloss model may be assumed, yet signals may be subject to penetration losses through a human body or other material where a free-space pathloss model is inappropriate. On the other hand, in certain circumstances (e.g. corridors) the actual pathloss may be lower than would be assumed by the model at the same separation.

There is thus a need to provide an effective and efficient technique for determining a separation distance between devices.

Embodiments of the present technique can provide a method for allowing one or both of a first wireless communications device and a second wireless communications device to determine an estimate of a distance between the first and second wireless communication devices, the method comprising while operating in a first mode of operation, receiving by the second wireless communications device a first type signal as a beacon signal requesting the second wireless communications device to transmit a second type signal, the beacon signal transmitted by the first wireless communications device, in response to receiving the beacon signal, the second wireless communications device transmitting the second type signal, the second type signal being a first synchronisation signal and indicating that the first wireless communications device is to transmit a second synchronisation signal, determining a first time at which the first synchronisation signal is transmitted, and operating in a second mode of operation in which the first device monitors for a second type signal transmitted by the first wireless communications device in response to the first synchronisation signal. The method further comprises receiving a second synchronisation signal transmitted by the first device, and determining a second time at which the second synchronisation signal is received, wherein one or both of the first wireless communications device and the second wireless communications device are able to determine the estimate of the distance between the first and second wireless communications devices, the estimate of the distance based on a first duration and a second duration, the second duration being a time period between the first time and the second time, the first duration being a time period between a third time and a fourth time, the third time being a time at which the first wireless communications device received the first synchronisation signal and the fourth time being a time at which the first wireless communications device transmitted the second synchronisation signal.

In accordance with embodiments of the present technique, in a first phase, one or more first type signals (which may be referred to herein generally as ‘beacons’) are transmitted by one or both of the first and second devices. In a second phase, one or more second type signals (which may be referred to herein generally as ‘synchronisation signals’) are transmitted by each of the first and second devices. In particular, a first synchronisation signal is transmitted by the second device, and a second synchronisation signal is transmitted, in response to the first synchronisation signal, by the first device.

The second device determines a first duration between the time of transmission by the second device of the first synchronisation signal and a reception (at the second device) of the second synchronisation signal. There is also determined (by the first and/or second device) a second duration between a time of reception at the first device of the first synchronisation signal and a transmission (by the first device) of the second synchronisation signal.

Based on the first duration and the second duration, the round trip time (RTT) for transmissions between the first and second devices can be determined. Based on the RTT, an estimate of the distance separating the devices can be obtained. The estimate of the distance may be determined by one or both of the first and second devices.

Embodiments of the present technique can thus provide a more reliable estimate of a distance separating devices than conventional techniques.

In some embodiments, the power consumption associated with the transmission or reception of the beacon signals is lower than the corresponding power consumption associated with the transmission or reception, respectively, of the synchronisation signals. Accordingly, embodiments can provide a power-efficient technique for estimating a distance between devices.

In some embodiments, subsequent transmissions of a third type signal (referred to generally herein as a ‘response’ signal) may provide information to allow both devices to determine the distance between them.

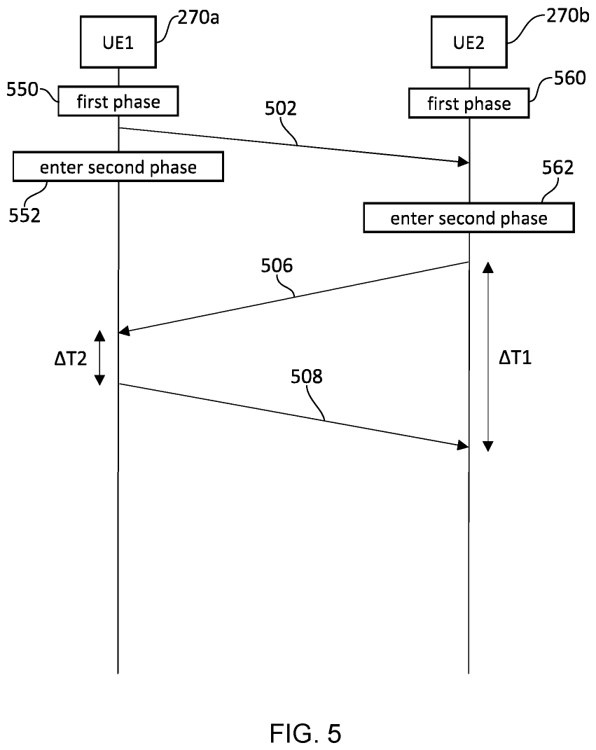

FIG. 5 illustrates a procedure for the determination of a distance estimation between the first device 270a and the second device 270b in accordance with embodiments of the present technique.

Initially, the first device 270a and second device 270b are in a first phase 550, 560. The first device transmits a beacon signal 502, and moves to the second phase 552.

In response to receiving the beacon signal 502, the second device 270b moves to the second phase 562 and transmits a first synchronisation signal 506, which is received by the first device 270a. In response to receiving the first synchronisation signal 506, the first device transmits a second synchronisation signal 508.

The second device 270b measures the time ΔT1 between the transmission of the first synchronisation signal 506 and the reception of the second synchronisation signal 508. The time ΔT2, between the reception of the first synchronisation signal 506 at the first device 270a and the transmission by the first device 270a of the second synchronisation signal 508 is also determined.

Based on the durations ΔT1 and ΔT2, the round-trip time for signals transmitted between the first and second devices 270a, 270b can be calculated as RTT=ΔT1−ΔT2. An estimate for the distance between the first and second devices 270a, 270b can be obtained as RTT×c÷2 where c is the propagation speed of radio frequency signals.

In some embodiments, the estimate of the distance is determined by both the first and second devices 270a, 270b. In some embodiments, the estimate of the distance is determined by one of the first and second devices 270a, 270b, and an indication of the estimated distance is transmitted to the other of the first and second devices 270a, 270b by means of a response signal transmitted after the synchronisation signals (not shown in the example of FIG. 5).

In some embodiments, the first device 270a transmits the beacon signal 502 in response to receiving an earlier-transmitted beacon signal (not shown in FIG. 5), transmitted by the second device 270b. Accordingly, in some such embodiments, the second device 270b enters the second phase in response to receiving a beacon (such as the beacon 502) transmitted in response to an earlier beacon transmitted by the second device 270b.

In some embodiments, instead of, or as well as determining the distance D, a determination as to whether the first and second devices are within a predetermined distance may be made by determining whether the estimated RTT is less than a threshold value corresponding to a threshold distance.

Details of the beacon transmission, synchronisation signals and response signals are now described.

Beacon Transmission

In accordance with embodiments of the present technique, in a first phase, one or more beacons are transmitted by one or both of the first and second devices which are operating in a first mode of operation.

A beacon is transmitted to request another device to respond by transmitting either a further beacon transmission (referred to as herein a ‘beacon response’ signal) or to request another device to enter a second phase and to transmit a synchronisation signal.

Preferably, the first mode of operation is a low power mode of operation. For example, where the device is operating in accordance with 3GPP UMTS, LTE or NR specifications, the beacon may be transmitted while the device is in a radio resource control (RRC) idle mode.

Preferably, the power consumption required for a receiver to receive and decode the beacon signal is low. For example, the beacon signal may be decodable by another device which is also in the first phase and is operating in the first mode of operation. Preferably, the beacon signal can be received and decoded by a device having no prior synchronisation with, or awareness of, the device which is transmitting the beacon.

The beacon signal may be transmitted in unlicensed spectrum. Accordingly, embodiments of the present technique can provide a proximity determination/distance estimation procedure which does not depend on the two devices being connected to the same (or indeed, any) wireless communications network.

In some embodiments, the beacon signal is transmitted using resources allocated for the purpose of such transmissions. The resources may be allocated by a government authority (e.g. as part of spectrum allocation), or may be allocated from a portion of licensed spectrum by a wireless communications network. Accordingly, embodiments of the present technique can provide for a reliable proximity determination/distance estimation procedure in which transmissions are unlikely to suffer from significant interference or collision.

In some example embodiments, the beacon signal is suitable for reception by a passive receiver. For example, the beacon signal may be based on an on-off keying (OOK) sequence. In some embodiments, the beacon signal may be based on a wake-up signal, such as that disclosed in international application PCT/EP2018/071659 [5], the contents of which are hereby incorporated by reference in their entirety.

Accordingly, embodiments of the present technique can provide for a distance estimating or proximity detection method where a beacon receiving device is able to continuously monitor for a beacon, without consuming a significant amount of power. Preferably, for example, the power consumption of a 3GPP-capable device which is capable of receiving and decoding a beacon signal is similar to that when the device is in an RRC idle mode of operation.

In some embodiments, the transmit power used for the transmission of the beacon signal may be set such that with high probability, the beacon can be received by a receiving device within a range of interest. Accordingly, the transmit power may be based on a range of interest (e.g. 10 m), using a conservative estimate for pathloss and penetration losses that may be incurred by the signal within that range.

In some embodiments, the beacon signal encodes information which may include one or more of the following:
an identity associated with a synchronisation signal that will be subsequently transmitted by the transmitter of the beacon signal; and
a purpose of the beacon (which may be based on an application used to trigger the beacon transmission).

In some embodiments, a beacon signal comprises a Bluetooth Low Energy (BLE) beacon.

In some embodiments, a beacon signal is transmitted periodically, where the periodicity may be determined by the application. For example, where the beacon is transmitted to support a contact tracing application where it is desired to determine any other devices which have been in proximity to the device for more than 10 minutes, the periodicity may be set at 1 minute (10% of the threshold contact time). In a pedestrian crossing application, it may be desired to determine the number of proximate devices every 5 seconds; accordingly, a device associated with a pedestrian crossing may transmit beacons every 5 seconds.

Accordingly, the beacon transmission periodicity may be determined based on an application associated with the device. Embodiments of the present technique can therefore provide a beacon transmission periodicity which avoids unnecessary power consumption, while satisfying requirements of an associated application.

In some embodiments, the beacon transmission is periodic with jitter. That is, if, according to the beacon periodicity, a next beacon would be transmitted at time T, then the beacon is transmitted at a time T′=T+r, where r is a random or pseudo-random quantity, and which may be positive or negative. Embodiments of the present technique can thus avoid beacons transmitted by different devices, having the same periodicity (or where the periodicity of one is an integer multiple of the periodicity of another) repeatedly colliding in time, such that one or more beacons cannot be correctly received by a second device.

In some embodiments, beacon transmission may be aperiodic, or on-demand. For example, a beacon transmission may be triggered by an application associated with the device. In some embodiments, a beacon transmission may be triggered by another sensor associated with the device. For example, a camera or image sensor may capture images which may contain another person. In response to receiving such images, the device may trigger the transmission of a beacon.

In the example of FIG. 5, the first device 270a transmits a beacon signal 502 (which may be an initial beacon signal), and the first and second devices 270a, 270b enter the second phase after transmitting (respectively, receiving) the beacon signal 502.

In some embodiments, after transmitting an initial beacon signal, a device monitors for a ‘beacon response’ signal transmitted by another device which has received the initial beacon signal. A device which transmits an initial beacon signal may move to the second phase only if it receives a beacon response signal transmitted in response to the initial beacon signal (e.g. comprising a sequence which corresponds to a sequence used in the initial beacon signal).

A device which receives an initial beacon signal may move to the second phase after transmitting the beacon response signal.

In some embodiments, a device only moves to the second phase in response to receiving a beacon signal at a received signal power greater than a predetermined threshold.

In some embodiments, a device which receives an initial beacon signal transmits a beacon response signal only if the received signal power of the initial beacon signal exceeds a predetermined threshold.

Accordingly, embodiments of the present technique can avoid a device moving to the second phase in respect of a peer device which is not located within a region of interest (i.e. is located too far from the device) and can thus avoid unnecessary power consumption.

Synchronisation Signal Transmission

In accordance with embodiments of the present technique, in a second phase, the devices operate in a second mode of operation. During the second phase, one or more second type signals (which may be referred to herein generally as ‘synchronisation signals’) are transmitted by each of the first and second devices. A synchronisation signal may be transmitted in response to receiving a beacon signal (which may be in some embodiments an initial beacon signal or, in some embodiments, a beacon response signal).

In some embodiments, as described above, a beacon signal may encode information, such as a purpose of the distance estimation or an application identity. In some such embodiments, a device receiving such a beacon may move to the second phase (or, in some embodiments, transmit a beacon response signal) depending on the encoded information. For example, where a pedestrian crossing device transmits a beacon indicating that the beacon is to initiate a proximity detection in respect of pedestrians, a device associated with a motor vehicle may not enter the second phase in response to such a beacon.

The synchronisation signal is suitable for accurate timing measurements, that is, it has good correlation properties to allow a receiver to accurately determine a time of arrival. Preferably, the sending device is configured to determine a time of transmission of the synchronisation signal with an accuracy such that the error is less than 0.5 ns.

Preferably, the receiver is configured to determine a time of reception of the synchronisation signal with an accuracy such that the error is less than 0.5 ns.

In some embodiments, the synchronisation signals may have a structure corresponding to one or more of the following signal structures:
a Zadoff-Chu sequence;
a sequence defined for use as a PSS or SSS for a 3GPP LTE or NR wireless access interface (including a PSS or SSS defined for use on a sidelink, referred to as Sidelink-PSS (S-PSS) or Sidelink-SSS (S-SSS));
a sequence defined for use on a physical random access channel (PRACH), such as a PRACH of a 3GPP LTE or NR wireless access interface;
a sequence defined for use as a PRS for a wireless access interface (such as a 3GPP LTE or 3GPP NR wireless access interface).

Embodiments of the present technique can therefore allow the re-use of existing functions and features, for the transmission and/or reception of signals, of a wireless communications device which is configured for transmission and reception of data on a 3GPP LTE or NR wireless access interface.

In some embodiments, a wireless communications network can allocate one or more specific signal structures (e.g. a PSS, SSS or PRACH preamble sequence) for use as synchronisation signals. The allocation may be indicated to the first and second devices by means of, for example, broadcast signalling or RRC configuration. Accordingly, embodiments of the present technique can ensure that a device can distinguish between a synchronisation signal and a similar signal used for a conventional purpose (PSS/SSS/PRACH) in the wireless communication. For example, a subset of PRACH sequences may be reserved for use as synchronisation signals.

In some embodiments, where the synchronisation signals are based on PRS, the PRS may be transmitted using a greater density (i.e. where a greater proportion of communication resources comprise a PRS OFDM waveform) than used in a wireless access interface of a conventional wireless communications network, such as a communications network operating in accordance with 3GPP LTE or 3GPP NR specifications.

Accordingly, embodiments of the present technique can allow for more accurate determination of a time of arrival of a signal compared with conventional PRS transmissions.

In some embodiments, the synchronisation signal encodes certain information. This information may comprise one or more both of:
an identity associated with a preceding initial beacon signal; and
an identity associated with a preceding beacon response signal.

Accordingly, embodiments of the present technique can permit a device to determine whether a received synchronisation signal is transmitted in response to a beacon which it has previously transmitted, or to determine that a received synchronisation signal was transmitted by a same device as an earlier-received beacon.

In some embodiments, a synchronisation signal is sent and transmitted by devices which are in an RRC connected mode.

In accordance with embodiments of the present technique, a device which transmits a synchronisation signal determines with high accuracy a delay between the transmission of the synchronisation signal and the reception of a previous or subsequent synchronisation signal. Based on such delays determined in respect of a pair of synchronisation signals, the round-trip time between the transmitting devices may be determined.

In some embodiments, a duration of a transmitted synchronisation signal is determined based on a received signal strength associated with a previously-received beacon signal. Accordingly, for example, if the received beacon is received at a low signal strength, the duration of the synchronisation signal is increased, in order to ensure an accurate measurement of the time of reception of the synchronisation signal. If the received beacon is received at a higher signal strength, the duration of the synchronisation signal may be shorter, in order to avoid unnecessary power consumption.

In some embodiments, during the second phase, one synchronisation signal is transmitted by each of the first and second devices 270a, 270b. In some embodiments, multiple pairs of first and second synchronisations signals 506, 508 may be transmitted, in order to provide an improved estimate the separation of the first and second devices. In such embodiments, the time durations ΔT1 and ΔT2 may be determined in respect of each pair of synchronisation signal transmissions.

In some embodiments, a number of pairs of synchronisation signals to be transmitted during the second phase is determined by the second device 270b based on the received signal strength of the beacon signal which it receives and, in response to which, the second device 270b enters the second phase.

For example, there may be one or more signal strength ranges, each associated with a number of pairs of synchronisation signals to be transmitted. For a range associated with lower signal strengths, the number of synchronisation signals to be transmitted may be higher than for a range associated with higher signal strengths.

Accordingly, embodiments of the present technique can provide more accurate estimates of round trip time (and hence of separation distance) where path loss between the devices is higher.

In some embodiments, the first and second devices 270a, 270b both transmit beacons during the first phase, and measure the received signal strength of the beacon signals that are transmitted by the second and first devices, respectively. Given that the pathloss for the channel between the devices is likely to be symmetric, both devices can accordingly determine the (same) number of synchronisation signals which are to be transmitted.

In some embodiments, the second device 270b receives one or more beacons during the first phase and measures the received signal strength of the beacon signal(s) that it receives from the first device 270a. Based on the received signal strength, the second device determines a number of synchronisation signals which are to be transmitted in the second phase and sends one or more synchronisation signals with a characteristic that is associated with that number of synchronisation signals. For example, the characteristic could be a sequence applied to the synchronisation signal.

In an example embodiment, if a beacon signal transmitted by the first device 270a is received by the second device 270b with a high signal strength (i.e. one that exceeds a first predetermined threshold), the second device determines only one synchronisation signal is to be transmitted. Accordingly, the second device 270b transmits a single synchronisation signal, to which a first sequence is applied, the first sequence indicating to the first device that only one synchronisation signal is to be transmitted by each of the first and second devices 270a, 270b. If, however, the beacon signal is received with a lower signal strength (lower than the first predetermined threshold), the second device determines that two synchronisation signals are to be transmitted. The second device 270b transmits each of the two synchronisation signals using a second sequence. The second sequence indicates to the first devices 270a that two synchronisation signals are to be transmitted by each device. Depending on the synchronisation signal sequence that the first device receives, the first device responds with the same number of synchronisation signals.

In some embodiments, the second device 270b determines the number of synchronisation signals to be transmitted. This may be based on a received signal strength associated with a beacon signal transmitted by the first device 270a during the first phase, as described above.

In some embodiments, the determination of the number of synchronisation signals required to be transmitted may be based on a determined accuracy of the round-trip time estimate which has been achieved using the synchronisation signals already transmitted and received. That is, for example, after each pair of synchronisation signals has been transmitted, the second device determines whether an accuracy of an estimate of the round-trip time based on the so-far transmitted synchronisation signals exceeds (or would exceed) a predetermined threshold.

If the accuracy is or would exceed the threshold, then the second device determines that no further synchronisation signals need to be transmitted.

An estimate of the accuracy may be obtained by determining, for each pair of synchronisation signals, a corresponding estimate of the RTT or separation distance. The mean and variance of these estimates may then be calculated. If a ratio of the variance to the mean is below a predetermined threshold, then the accuracy requirement may be considered to exceed the predetermined accuracy threshold.

The accuracy threshold or number of synchronisation pair transmissions required may vary according to the estimated separation distance and may additionally or alternatively depend on the application.

For example, for a contact-tracing application where it is of interest if devices have been within a range of 2 m from each other, then a first accuracy threshold may apply where the estimated separation distance is greater than 4 m, and a second accuracy threshold (corresponding to a greater accuracy) may apply to lower estimated distances.

In some embodiments, the second device may refrain from transmitting any further synchronisation signals in response to such a determination. In some embodiments, the second device may transmit a further synchronisation signal which encodes a ‘stop’ indication. For example, the further synchronisation signal may be a predetermined sequence associated with the stop indication.

In response to receiving a ‘stop’ indication (e.g. a synchronisation signal having the predetermined sequence associated with the stop indication), the first device 270a may stop monitoring for further synchronisation signals and enter a lower power mode of operation, such as the first mode of operation.

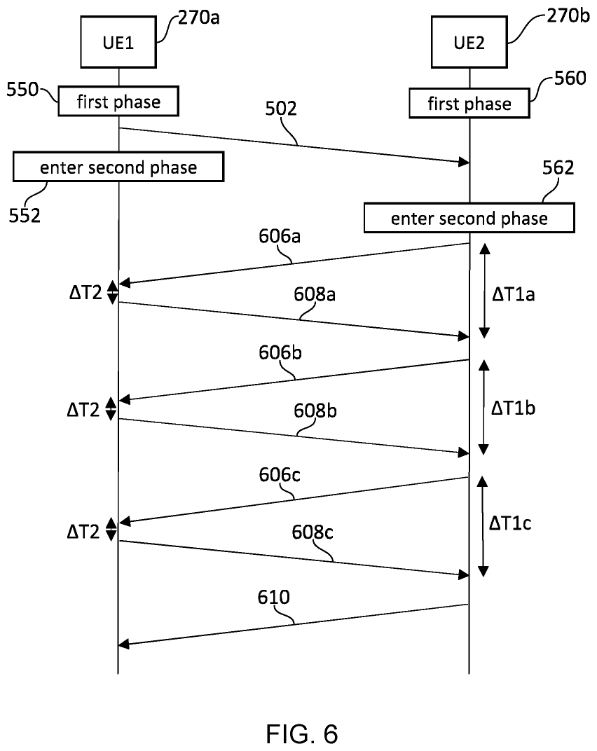

FIG. 6 illustrates the transmission of a plurality of pairs of synchronisation signals, and a ‘stop’ synchronisation signal, in accordance with embodiments of the present technique. In the example of FIG. 6, the second device 270b determines that three pairs of synchronisation signals are to be transmitted: a first pair 606a, 608a, a second pair 606b, 608b and a third pair, 606c, 608c.

After receiving the second synchronisation signal of the third pair 608c, the second device 270b transmits a further synchronisation signal 610 to the first device 270a, which encodes a ‘stop’ indication.

In response to receiving the synchronisation signal 610 and determining that it encodes a ‘stop’ indication, the first device 270a refrains from transmitting further synchronisation signals. The first device 270a may also stop monitoring for further synchronisation signals from the second device and enter a lower power mode of operation.

An estimate of the round-trip time (or separation distance) may be determined for each pair of synchronisation signals, based on the corresponding values of ΔT1 and ΔT2 associated with each pair.

In some embodiments, the transmissions of repeated synchronisation signals by the same device are separated in time by an amount which is not an integer multiple of a sampling period of the receiver of the other device. Alternatively, a sampling process at the receiver is configured so that sampling times of a first received synchronisation signal are different, relative to the synchronisation signal waveform, from sampling times used for a second received synchronisation signal.

By applying such an offset at either the transmitter or receiver, the receiver of the synchronisation signal can obtain an improved estimate of the time of receipt of the synchronisation signals.

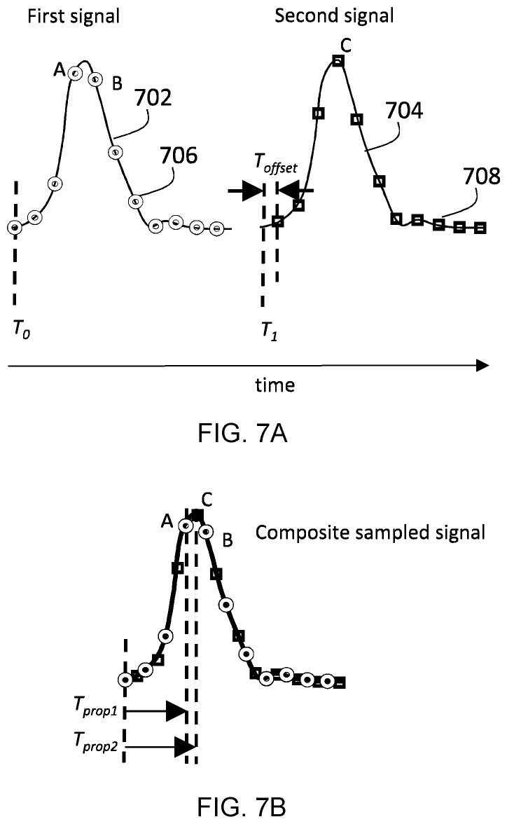

FIG. 7A and FIG. 7B illustrate an example of multiple synchronisation signals being sampled at different relative times.

FIG. 7A shows a first synchronisation signal 702 and second synchronisation signal 704 as received at a receiver of either the first device or the second device. The times at which receipt of the first and second synchronisation signals 702, 704 begin are denoted by T0 and T1 respectively.

The received synchronisation signals are sampled at first time instants 706 in respect of the first synchronisation signal 702, and at second time instants 708 in respect of the second synchronisation signal 704. As a result of an offset applied to one or both of the transmission time or sampling times of the second synchronisation signal, the second time instants 708 are displaced, relative to their respective synchronisation signal, by an amount T_{offset}, which is smaller than the sample period at the receiver (i.e. the time between successive samples).

If T_{offset} is known at the receiver, then the sampled signals corresponding to the first and second synchronisation signals can be combined to obtain a better estimate of the time of receipt of each. For example, if the time of receipt is determined based on the peak value of the first synchronisation signal 702 alone, the receiver cannot determine where that peak occurs between sample A and sample B. Similarly, considering only the samples obtained from the second synchronisation signal, it cannot be determined whether the peak of the signal occurs at, before, or after sample C.

However, by combining the samples from the first and second synchronisation signals, as shown in FIG. 7B, it can be identified that a better estimate of the time of receipt of both signals can be given by the timing corresponding to point C.

It will be appreciated that such combination (and thus, enhanced estimate) can be performed even if the value of T_{offset} is not known, given that the waveform associated with both synchronisation signals is known. In some embodiments, T_{offset} arises as a result of clock drift at the receiver.

Accordingly, in some embodiments, a time between successive transmissions of synchronisation signals may be set to a duration which corresponds to a duration over which clock drift is expected to exceed a minimum portion of a sample period (for example, 10%), in order to provide, in effect, oversampling of the successive synchronisation signals.

In some embodiments, the offset may be realised by applying a phase offset to the transmitted or received signals. The offset may additionally or alternatively be realised by applying a frequency offset to the receiver clock which is used to control the sampling process.

In some embodiments, as described above, one or more pairs of synchronisation signals are transmitted, where a pair comprises a first synchronisation signal (such as the first synchronisation signal 506 in the example of FIG. 5 or the first synchronisation signals 606 in the example of FIG. 6) and a second synchronisation signal (such as the second synchronisation signal 508 in the example of FIG. 5 or the second synchronisation signals 608 in the example of FIG. 6. In general, the first synchronisation signal of a pair may be the one transmitted by the device (such as the second device 270b) which transmits the first synchronisation signal of those transmitted after the first and second devices have entered the second phase. The second synchronisation signal of a pair may be one sent in response to receiving a first synchronisation signal of a pair, and may be sent by the device (such as the first device 270a) which transmits the second synchronisation signal of those transmitted after the first and second devices have entered the second phase.

In some embodiments, such as in the example illustrated in FIG. 6, the duration ΔT2 between the reception by the first device 270a of a first synchronisation signal 606 and the transmission of a corresponding second synchronisation signal 608 is constant and is predetermined. Accordingly, the second communications device 270b determines this duration to be equal to the predetermined duration.

The predetermined value may be in accordance with a standards specification, may be negotiated during an earlier pairing operation (such as a Bluetooth pairing operation) between the first and second devices, or may be configured by a wireless communications network. The earlier pairing operation may comprise any communications between the devices which results in each of them identifying the other device. For example, the pairing operation may be an IEEE 802.11 association procedure or a 3GPP sidelink association procedure.

In some embodiments, ΔT2 is selected from a plurality of permitted values ΔT2a, ΔT2b, ΔT2c, . . . , such that the selected value can be determined by the second device 270b without any additional signalling between the first and second devices 270a, 270b. In some such embodiments, the plurality of permitted values are such that the difference between any two values is greater than a maximum expected one-way propagation delay for signals transmitted from the first device to the second device.

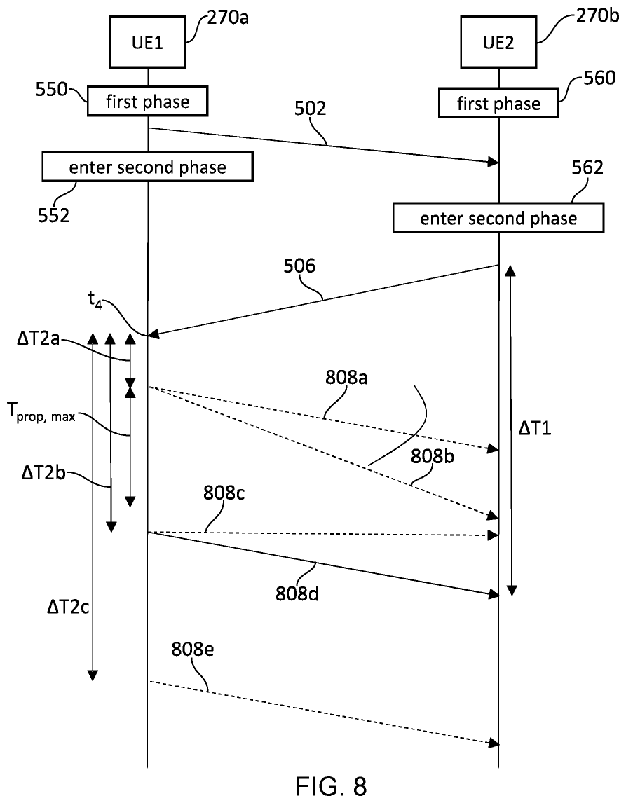

FIG. 8 illustrates an example embodiment in which the duration ΔT2 is selected from a plurality of predetermined values, in accordance with embodiments of the present technique.

FIG. 8 shows the transmission of the beacon signal 502 and first synchronisation signal 506 as in the example of FIG. 5 described above. The first synchronisation signal 506 is received by the first device 270a at time t4.

In accordance with some embodiments of the present technique, the first device 270a is permitted to choose any of a plurality of times for the transmission of the second synchronisation signal 808. These times are defined by permitted values of ΔT2, which are shown as ΔT2a, ΔT2c, ΔT2c in FIG. 8.

In the example of FIG. 8, the plurality of permitted values of ΔT2 are such that the second device 270b can determine the actual value of ΔT2 based on the time of reception of the second synchronisation signal 808. To illustrate this, dashed lines 808b and 808c show, respectively, second synchronisation signals which are a) transmitted based on a lower ΔT2 value, ΔT2a, and which are subject to a highest expected propagation delay for signals between the first and second devices (T_{prop, max}), and b) transmitted based on a higher ΔT2 value, ΔT2b, and which are subject to a zero propagation delay. It can be seen from FIG. 8 that in either case, the selected value of ΔT2 is unambiguous, and can thus be determined by the second device 270b without further explicit signalling from the first device 270a.

In the example of FIG. 8, the first device 270a selects, as the ΔT2 value, ΔT2b. Accordingly, the second synchronisation signal is transmitted as indicated by the solid arrow 808d. Dashed arrows 808a, 808e show the second synchronisation signal if it had instead been transmitted in accordance with permitted ΔT2 values of ΔT2a and ΔT2c, respectively.

In some embodiments, the second synchronisation signal 808 encodes the value of ΔT2. For example, the first device 270a may select a value of ΔT2 from a plurality of predetermined values, each of which is associated with a particular sequence. The sequence associated with the selected ΔT2 value is applied to the second synchronisation signal 808. Accordingly, the second device 270b can determine the sequence applied to the second synchronisation signal 808, and accordingly determine the value of ΔT2, based on the predetermined association between the sequence and the value of ΔT2.

In some embodiments, the plurality of permitted values of ΔT2 are related by the equation ΔT2ₙ=ΔT2ₘᵢₙ+(n x ΔT2_{quant}), for some range of values of n. As described above, in some embodiments, ΔT2_{quant} may be greater than a one-way propagation delay associated with a maximum separation between the first and second devices.

In general, in some embodiments, when selecting the value of ΔT2 from a plurality of predetermined values, a minimum possible value is selected. A value/duration may be considered not possible due to processing capabilities of the first device (i.e. it is not possible to complete the reception and decoding of the first synchronisation signal and to prepare to transmit the second synchronisation schedule within the duration). A value/duration may not be possible if the first device performs, unsuccessfully, a ‘listen-before-talk’ (LBT) procedure. An LBT procedure may comprise a clear channel assessment (CCA) in respect of the carrier frequency range to be used for the second synchronisation signal.

A successful LBT procedure (i.e. one where the result indicates that the second synchronisation signal may be transmitted) may be required prior to the transmission of the second synchronisation signal in accordance with regulations applicable to the spectrum resources to be used for the transmission of the second synchronisation signal. For example, where the spectrum resources are within ‘unlicensed’ spectrum, regulations may require a successful LBT procedure before transmission of the second synchronisation signal.

In some embodiments, the LBT procedure may be a conventional LBT procedure defined for the relevant spectrum. For example, the LBT procedure may be one defined by IEEE 802.11 specifications applicable to the spectrum.

Accordingly, referring to the example of FIG. 8, in accordance with some embodiments of the present technique, the first device 270a may select ΔT2=ΔT2b because transmitting the second synchronisation signal 808 at time t4+ΔT2a is not possible in view of the capabilities of the first device. In some embodiments, additionally or alternatively, the first device 270a may select ΔT2=ΔT2b because an LBT procedure performed prior to time t4+ΔT2a was unsuccessful, but a subsequent LBT procedure prior to t4+ΔT2b was successful.

In embodiments where the first device 270a may send a second synchronisation signal at one of a number of quantised times, ΔT2, the second device 270b may determine the actual value of ΔT2 (i.e. which quantised value was applied by the first device 270a) by determining a smallest permitted value of ΔT2 which corresponds to a non-negative propagation delay. For example, the second device 270b may consider a set of hypotheses, each associated with one of the permitted values, of which quantised value was applied and determine the quantised value used by the first device based on the hypothesis that leads to the smallest non-negative calculated propagation delay.

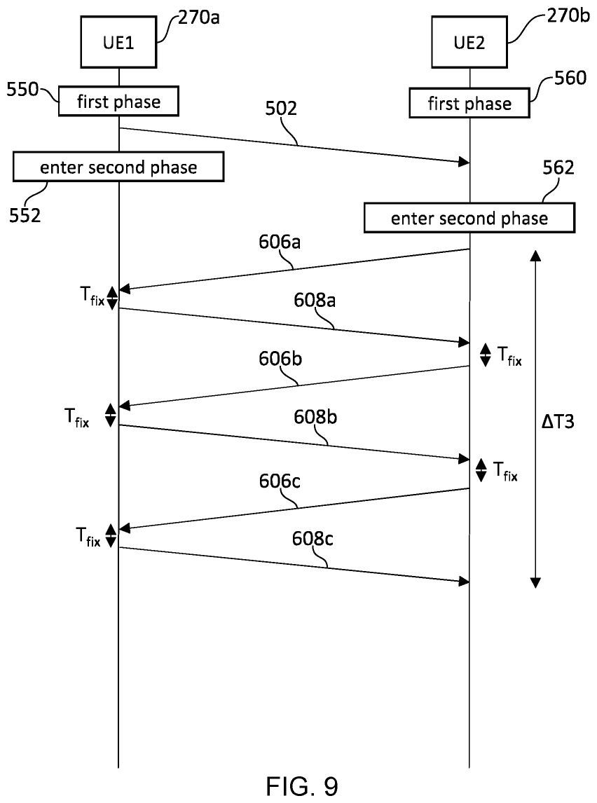

In some embodiments, during the second phase (i.e. when the first and second devices 270a, 270b are in the second mode of operation), a plurality of pairs of synchronisation signals are transmitted. FIG. 9 illustrates a use of multiple pairs of synchronisation signals in accordance with such embodiments of the present technique. FIG. 9 is similar to FIG. 6, except that no synchronisation signal encoding ‘stop’ is shown in FIG. 9.

In such embodiments, the time between the reception of a synchronisation signal by a device and the transmission of a subsequent synchronisation signal by the same device is a predetermined duration, T_{fix}. In the example of FIG. 9, the number of synchronisation signals transmitted is predetermined (three pairs of two). It will be appreciated that the number of synchronisation signals may not be predetermined but may be determined in any suitable manner, such as in accordance with techniques disclosed herein.

The second device 270b measures the time ΔT3 from the transmission of the first synchronisation signal 606a until the time of reception of the last synchronisation signal 608c.

The round trip time (RTT) can be estimated as (ΔT3−((2N−1) x T_{fix}))÷N, where N is the number of pairs of synchronisation signals transmitted (in the example of FIG. 9, N=3). An estimate of the separation distance can be determined as described above, based on the estimated RTT.

In some embodiments, the value of N is predetermined.

In the example of FIG. 9, the time between the reception of a synchronisation signal and the transmission of a subsequent synchronisation signal is constant (i.e. T_{fix}). In some other embodiments, the time between the reception of a synchronisation signal and the transmission of a subsequent synchronisation signal varies during the sequence of synchronisation signals.

For example, the time between the reception of an nth synchronisation signal and the transmission of an (n+1)th subsequent synchronisation signal may vary for different values of n, e.g. may be a duration T_{fix}(n).

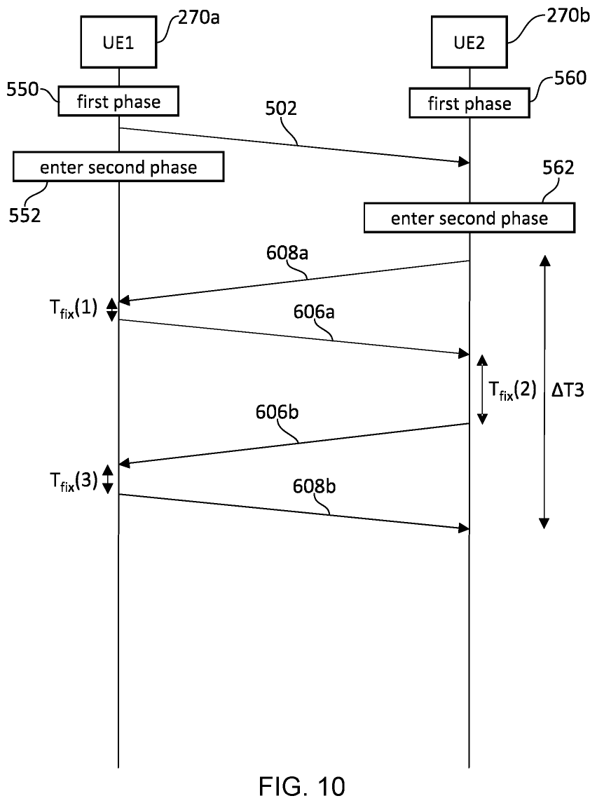

FIG. 10 illustrates the transmission of a sequence of synchronisation signals where the time between the reception of an nth synchronisation signal and the transmission of an (n+1)th subsequent synchronisation signal varies, in accordance with embodiments of the present technique.

In the example of FIG. 10, two pairs of synchronisation signals are transmitted: a first pair 606a, 608a, and a second pair 606b, 608b.

The time between the reception of each synchronisation signal and the transmission of the subsequent synchronisation signal is indicated by T_{fix}(n), for n=1, 2, 3. The values of T_{fix}(n) may be predetermined and known in advance to both the first and second devices 270a, 270b. In some embodiments, T_{fix}(n) may be known only to the respective device which is responsible for transmitting the (n+1)th synchronisation signal, and such values of T_{fix}(n) (or the sum thereof) may be indicated to the other device by means of signalling.

Where the second device 270b knows (or receives an indication of) the values of T_{fix}(n) for all values of n, the second device 270b may determine the estimate of the round trip time by measuring the time ΔT3, subtracting each of the T_{fix}(n) values, and dividing by the number of pairs of synchronisation signals that were transmitted (e.g. in the example of FIG. 10, two).

Response Signal

As disclosed elsewhere herein, in accordance with some embodiments of the present technique, the second device 270b may determine an estimate of the round-trip time, and hence an estimate of the distance separating the first and second devices 270a, 270b, without any further signalling after the synchronisation signals have been transmitted and received.

In accordance with some embodiments of the present technique, after the desired (or predetermined) number of synchronisation signals have been transmitted and received, the first and second devices 270a, 270b enter a third phase, during which one or more third type signals (which may be referred to herein generally as ‘response signals’) are transmitted.

In some embodiments, a response signal may encode (i.e. may comprise an indication of) one or more of:
an indication of a time of reception of each received synchronisation signal;
an indication of a time of transmission of each transmitted synchronisation signal;
an indication of a time between reception and transmission of successive synchronisation signals;
an indication of a time between reception and transmission of first and last (respectively) synchronisation signals in a sequence of synchronisation signals within a procedure;
an indication of a time between transmission and reception of first and last (respectively) synchronisation signals in a sequence of synchronisation signals within a procedure;
an indication of an estimated round-trip time for signals between the devices;
an indication of an estimated range (i.e. distance between first and second devices);
an indication of a purpose of initiating proximity determination/distance estimation process;
an application ID, for example a unique ID associated with an application which triggered the proximity/distance determination process; this could trigger the receiving device to pass the resulting distance estimate to an application running on the receiving device, which is associated with the application ID; and
an identity associated with a user of the device, which may be assigned by an application.

The response signal(s) may be transmitted via a device-to-device sidelink, or via a wireless communications network. For example, the response signals may not be transmitted directly between the first device and the second device. In some embodiments, an infrastructure equipment (e.g. the infrastructure equipment 272 of FIG. 3) may act as a relay for the response signal, and the response signal may accordingly comprise, for example, RRC signalling which is terminated at the infrastructure equipment 272, and relayed using further RRC signalling to the other device.

In some embodiments, where the response signal is transmitted via a wireless communications network, the response signal may be sent in accordance with a known technique for early data transmission (i.e. whereby user data may be transmitted to an infrastructure equipment prior to the establishment of an RRC connection).

In some embodiments, the response signal may be transmitted as user data via the wireless communications network.

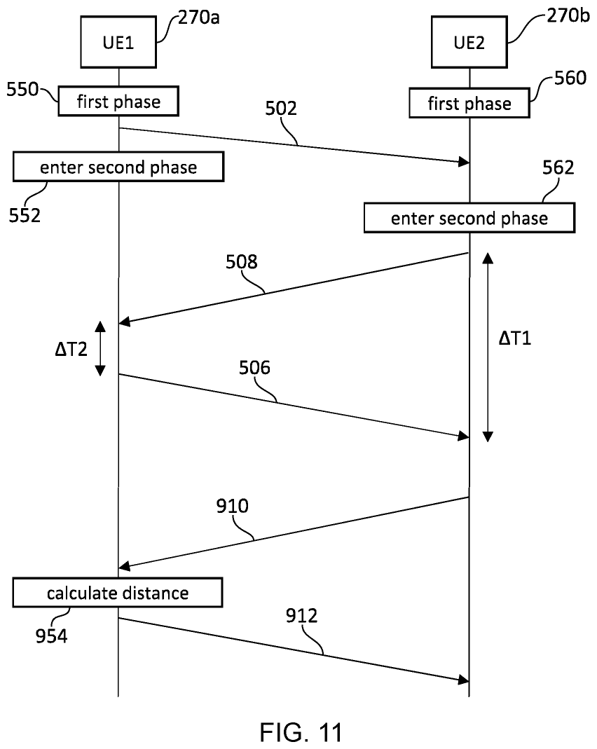

FIG. 11 illustrates the transmission of response signals after the transmission of synchronisation signals, in accordance with embodiments of the present technique.

In FIG. 11, beacon and synchronisation signals are transmitted as in the example of FIG. 5 described above. In the example of FIG. 11, the second device 270b does not determine the value of the duration ΔT2. After the transmission of the second synchronisation signal 508, the second device 270b transmits a first response signal 910 to the first device 270a. The first response signal 910 comprises an indication of ΔT1.

In response to receiving the first response signal 910, at step 954, the first device 270a is able to determine an estimate of the round-trip time based on ΔT1 and ΔT2 as described above, and accordingly determines an estimate of the distance separating the first device 270a and the second device 270b.

The first device 270a then transmits a second response signal 912 to the second device 270b. The second response signal 912 comprises an indication of the estimated distance separating the first device 270a and the second device 270b.

In some embodiments, only one response signal may be transmitted. For example, a response signal may be transmitted from the first device 270a to the second device 270b, comprising an indication of the value of ΔT2.

In some embodiments, the second response signal 912 may comprise an indication of the value of ΔT2. In response to receiving such an indication, the second device 270b calculates the round trip time and may calculate the distance, in the same manner as the first device 270a at step 954.

Completion

After the synchronisation signals and, in some embodiments the response signals, have been transmitted, the procedure may end and the first and second devices 270a, 270b may return to the first mode of operation (e.g. RRC idle mode). There may subsequently be a further transmission of beacon signals in accordance with the beacon periodicity described above, which may result in a further procedure for estimating the distance between devices being completed.

In some embodiments, a device, having entered the second phase in response to receiving a beacon and having completed a distance estimation or proximity determination procedure as described above, may refrain from entering the second phase, irrespective of any beacons received, for a predetermined duration. In some embodiments, beacon signals encode an identity of the transmitting device (which may be randomly selected, used for a time period, and/or may not be globally unique). In some embodiments, a device refrains from entering the second phase in response to receiving a beacon indicating an identity of a device which corresponds to an identity indicated by a beacon in which a recent distance/proximity estimation procedure has been completed within a predetermined duration.

Similarly, a device which has completed a procedure may refrain from transmitting any further beacons (either at all, or in response to those indicating an identity of a device with which a procedure has been recently completed) for a predetermined duration.

The behaviour in response to receiving such a subsequent beacon may depend on an application or purpose of the new beacon or the previous procedure. For example, when used on the request of (or as part of) an application for recovering lost items, no such restrictions may be applied, so that a distance estimation procedure may be performed repeatedly to attempt to locate the item. As another example, in a geo-caching application, devices which have been in confirmed proximity may refrain from entering the second phase at all for a period of time (e.g. 5 minutes). As yet another example, in a contract-tracing, public health application, a device may refrain from entering the second phase in response to a beacon for a period of one minute after having completed a distance estimation with the same peer device.

Accordingly, embodiments of the present technique can avoid wasted power consumption associated with repeated proximity/distance-determining processes in respect of the same pair of devices.

In some embodiments, a device may receive multiple synchronisation signals, from different devices, in response to a transmitted beacon signal. Accordingly, in some embodiments, a device may perform the proximity determination/distance-estimating process in respect of a plurality of different devices in parallel.

The maximum number of such other devices with which the device can perform such a process concurrently may be configured by a wireless communications network and/or may be a capability parameter associated with the device.

There has been described techniques for estimating a distance between two devices (or determining whether two devices are within a predetermined distance from each other). Aspects of these techniques may be combined in combinations other than explicitly described above. For example, the use of a ‘stop’ indication may be applied in combination with the example techniques for determining (and/or indicating) ΔT2 other than those described in conjunction with the example of FIG. 6.

Thus there has been described a method of operating a first wireless communications device for allowing one or both of the first wireless communications device and a second wireless communications device to determine an estimate of a distance between the first and second wireless communication devices, the method comprising while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation, after transmitting the first type signal, operating in a second mode of operation in which the first wireless communications device monitors for a second type signal transmitted by the second wireless communications device in response to the first type signal, receiving the second type signal, the second type signal being a first synchronisation signal, determining a first time at which the second type signal is received, and in response to receiving the first synchronisation signal, the first wireless communications device transmitting at a second time a second synchronisation signal, wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the second synchronisation signal.

There has also been described a method of operating a first wireless communications device for allowing one or both of the first wireless communications device and a second wireless communications device to determine an estimate of a distance between the first and second wireless communication devices, the method comprising while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation, after transmitting the first type signal, operating in a second mode of operation in which the first wireless communications device monitors for a second type signal transmitted by the second wireless communications device in response to the first type signal, receiving the second type signal, the second type signal being a first synchronisation signal, determining a first time at which the second type signal is received, and repeating, a number of times, the steps of: in response to receiving the first or a further synchronisation signal, transmitting a synchronisation signal, and receiving a further synchronisation signal, in response to receiving a further synchronisation signal, transmitting at a second time a final synchronisation signal, wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the final synchronisation signal.

There has further been described a method for allowing one or both of a first wireless communications device and a second wireless communications device to determine an estimate of a distance between the first and second wireless communication devices, the method comprising while operating in a first mode of operation, receiving by the second wireless communications device a first type signal as a beacon signal requesting the second wireless communications device to transmit a second type signal, the beacon signal transmitted by the first wireless communications device, in response to receiving the beacon signal, the second wireless communications device transmitting the second type signal, the second type signal being a first synchronisation signal and indicating that the first wireless communications device is to transmit a second synchronisation signal, determining a first time at which the first synchronisation signal is transmitted, and operating in a second mode of operation in which the second wireless communications device monitors for a second type signal transmitted by the first wireless communications device in response to the first synchronisation signal, receiving a second synchronisation signal transmitted by the first wireless communications device, and determining a second time at which the second synchronisation signal is received, wherein one or both of the first wireless communications device and the second wireless communications device are able to determine the estimate of the distance between the first and second wireless communications devices, the estimate of the distance based on a first duration and a second duration, the second duration being a time period between the first time and the second time, the first duration being a time period between a third time and a fourth time, the third time being a time at which the first wireless communications device received the first synchronisation signal and the fourth time being a time at which the first wireless communications device transmitted the second synchronisation signal.

Corresponding apparatus, circuitry and computer readable media have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches can be applied in respect of any type of wireless communications device capable of transmitting to another wireless communications device.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a first wireless communications device for allowing one or both of the first wireless communications device and a second wireless communications device to determine an estimate of a distance between the first and second wireless communication devices, the method comprising while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation, after transmitting the first type signal, operating in a second mode of operation in which the first wireless communications device monitors for a second type signal transmitted by the second wireless communications device in response to the first type signal, receiving the second type signal, the second type signal being a first synchronisation signal, determining a first time at which the second type signal is received, and in response to receiving the first synchronisation signal, the first wireless communications device transmitting at a second time a second synchronisation signal, wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the second synchronisation signal.

Paragraph 2. A method according to paragraph 1, the method comprising determining the estimate of the distance between the first and second wireless communication devices based on the first duration and the second duration.

Paragraph 3. A method according to paragraph 2, wherein determining the estimate of the distance between the first and second wireless communication devices based on the first duration and the second duration comprises receiving an indication of the estimate of the distance, the indication transmitted by the second wireless communications device.

Paragraph 4. A method according to paragraph 3, wherein the indication of the estimate of the distance is received from an infrastructure equipment of a wireless communications network.

Paragraph 5. A method according to paragraph 2, the method comprising receiving by the first wireless communications device an indication of the second duration, the indication of the second duration being transmitted by the second wireless communications device.

Paragraph 6. A method according to any of paragraphs 1 to 5, wherein the first duration is a predetermined duration.

Paragraph 7. A method according to any of paragraphs 1 to 5, the method comprising transmitting an indication of the first duration to the second wireless communications device.

Paragraph 8. A method according to any of paragraphs 1 to 5, the method comprising selecting one of a plurality of predetermined durations, and before transmitting the second synchronisation signal, determining the second time based on the first time and the selected duration.

Paragraph 9. A method according to any of paragraphs 1 to 8, wherein the beacon signal is transmitted at a power level, the method comprising determining the power level based on an application to which the estimate of the distance is to be provided.

Paragraph 10. A method according to any of paragraphs 1 to 9, wherein the first type signal is a Bluetooth Low Energy beacon signal.

Paragraph 11. A method according to any of paragraphs 1 to 10, the method comprising receiving, while in the first mode of operation, another first type signal transmitted as a beacon signal by the second wireless communications device, wherein transmitting the first type signal as a beacon signal is in response to receiving the beacon signal transmitted by the second wireless communications device. Paragraph 12. A method according to paragraph 11, the method comprising determining a received power level associated with the other first type signal, wherein transmitting the first type signal as a beacon signal is in response to determining that the received power level associated with the other first type signal is above a predetermined threshold.

Paragraph 13. A method according to any of paragraphs 1 to 12, wherein the first wireless communications device is configured to transmit and receive signals on a wireless access interface provided by an infrastructure equipment of a wireless communications network, and the method comprises receiving a signal having a same structure as the second type signal, the signal transmitted by the infrastructure equipment for allowing the first wireless communications device to synchronise with the infrastructure equipment or for determining a location of the first wireless communications device. Paragraph 14. A method according to paragraph 13, wherein the signal transmitted by the infrastructure equipment is one of a primary synchronisation signal (PSS), a secondary synchronisation signal (SSS) or a positioning reference signal (PRS).

Paragraph 15. A method according to any of paragraphs 1 to 12, wherein the first wireless communications device is configured to transmit and receive signals on a wireless access interface provided by an infrastructure equipment of a wireless communications network, and the second type signal has a same structure as a random access preamble for transmission on a random access channel of the wireless access interface.

Paragraph 16. A method according to paragraph 15, the method comprising transmitting to the infrastructure equipment on the random access channel of the wireless access interface the random access preamble.

Paragraph 17. A method according to any of paragraphs 1 to 16, wherein the beacon signal is selected from one of a plurality of beacon signal sequences.

Paragraph 18. A method according to paragraph 17, wherein the first synchronisation signal comprises one of a plurality of synchronisation signal sequences, the method comprising determining that the one of the plurality of synchronisation signal sequences is associated with the one of the plurality of beacon signal sequences.

Paragraph 19. A method according to any of paragraphs 1 to 20, the method comprising, after transmitting the second synchronisation signal, carrying out a number of times the steps of receiving a second type signal, the second type signal being a synchronisation signal, determining a time at which the second type signal is received, and in response to receiving the synchronisation signal, transmitting a synchronisation signal, wherein the second wireless communications device is able to determine a duration of each time period between the time at which the second type signal is received and a time at which the synchronisation signal is transmitted in response.

Paragraph 20. A method according to paragraph 19, wherein the number of times is predetermined.

Paragraph 21. A method according to paragraph 19, wherein the number of times is determined based on a received signal strength associated with the beacon signal.

Paragraph 22. A method according to paragraph 19 or paragraph 21, wherein the number of times is determined based on an estimated accuracy of an estimate of the distance between the first and second wireless communications devices.

Paragraph 23. A method of operating a first wireless communications device for allowing one or both of the first wireless communications device and a second wireless communications device to determine an estimate of a distance between the first and second wireless communication devices, the method comprising while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation, after transmitting the first type signal, operating in a second mode of operation in which the first wireless communications device monitors for a second type signal transmitted by the second wireless communications device in response to the first type signal, receiving the second type signal, the second type signal being a first synchronisation signal, determining a first time at which the second type signal is received, and repeating, a number of times, the steps of: in response to receiving the first or a further synchronisation signal, transmitting a synchronisation signal, and receiving a further synchronisation signal, in response to receiving a further synchronisation signal, transmitting at a second time a final synchronisation signal, wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the final synchronisation signal.

Paragraph 24. A method according to paragraph 23, wherein the steps are repeated a predetermined number of times.

Paragraph 25. A method according to paragraph 23 or paragraph 24, wherein in one repetition of the steps, receiving a further synchronisation signal comprises receiving an indication that no additional further synchronisation signal will be transmitted by the second wireless communications device.

Paragraph 26. A method for allowing one or both of a first wireless communications device and a second wireless communications device to determine an estimate of a distance between the first and second wireless communication devices, the method comprising while operating in a first mode of operation, receiving by the second wireless communications device a first type signal as a beacon signal requesting the second wireless communications device to transmit a second type signal, the beacon signal transmitted by the first wireless communications device, in response to receiving the beacon signal, the second wireless communications device transmitting the second type signal, the second type signal being a first synchronisation signal and indicating that the first wireless communications device is to transmit a second synchronisation signal, determining a first time at which the first synchronisation signal is transmitted, and operating in a second mode of operation in which the second wireless communications device monitors for a second type signal transmitted by the first wireless communications device in response to the first synchronisation signal, receiving a second synchronisation signal transmitted by the first wireless communications device, and determining a second time at which the second synchronisation signal is received, wherein one or both of the first wireless communications device and the second wireless communications device are able to determine the estimate of the distance between the first and second wireless communications devices, the estimate of the distance based on a first duration and a second duration, the second duration being a time period between the first time and the second time, the first duration being a time period between a third time and a fourth time, the third time being a time at which the first wireless communications device received the first synchronisation signal and the fourth time being a time at which the first wireless communications device transmitted the second synchronisation signal.

Paragraph 27. A method according paragraph 26, the method comprising determining an estimate of a distance between the first and second wireless communication devices based on the first duration and the second duration.

Paragraph 28. A method according to paragraph 27, the method comprising transmitting an indication of the estimate of the distance.

Paragraph 29. A method according to paragraph 27, wherein the indication of the estimate of the distance is transmitted to an infrastructure equipment of a wireless communications network.

Paragraph 30. A method according to any of paragraphs 26 to 29, the method comprising transmitting to the first wireless communications device an indication of the second duration.

Paragraph 31. A method according to any of paragraphs 26 to 30, wherein the first duration is a predetermined duration.

Paragraph 32. A method according to any of paragraphs 26 to 30, the method comprising receiving an indication of the first duration.

Paragraph 33. A method according to any of paragraphs 26 to 30, wherein the first duration is selected by the first wireless communications device from a plurality of predetermined durations.

Paragraph 34. A method according to any of paragraphs 26 to 33, the method comprising determining a received power level associated with the first type signal, wherein transmitting the first synchronisation signal is in response to determining that the received power level associated with the first type signal is above a predetermined threshold.

Paragraph 35. A method according to any of paragraphs 26 to 34, wherein the first type signal is a Bluetooth Low Energy beacon signal.

Paragraph 36. A method according to any of paragraphs 26 to 35, the method comprising transmitting, while in the first mode of operation, another first type signal transmitted as a beacon signal, wherein the beacon signal transmitted by the first wireless communications device is transmitted in response to the other beacon signal transmitted by the second wireless communications device.

Paragraph 37. A method according to any of paragraphs 26 to 36, wherein the second wireless communications device is configured to transmit and receive signals on a wireless access interface provided by an infrastructure equipment of a wireless communications network, and the method comprises receiving a signal having a same structure as the second type signal, the signal transmitted by the infrastructure equipment for allowing the second wireless communications device to synchronise with the infrastructure equipment or for determining a location of the second wireless communications device. Paragraph 38. A method according to paragraph 33, wherein the signal transmitted by the infrastructure equipment is one of a primary synchronisation signal (PSS), a secondary synchronisation signal (SSS) or a positioning reference signal (PRS).

Paragraph 39. A method according to any of paragraphs 26 to 36, wherein the second wireless communications device is configured to transmit and receive signals on a wireless access interface provided by an infrastructure equipment of a wireless communications network, and the second type signal has a same structure as a random access preamble for transmission on a random access channel of the wireless access interface.

Paragraph 40. A method according to any of paragraphs 26 to 39, wherein the beacon signal is selected from one of a plurality of beacon signal sequences.

Paragraph 41. A method according to paragraph 40, wherein the first synchronisation signal comprises one of a plurality of synchronisation signal sequences, the method comprising determining that the one of the plurality of synchronisation signal sequences is associated with the one of the plurality of beacon signal sequences.

Paragraph 42. A method according to any of paragraphs 26 to 41, the method comprising, after receiving the second synchronisation signal, carrying out a number of times the steps of transmitting a second type signal, the second type signal being a synchronisation signal, determining a time at which the second type signal is transmitted, receiving a synchronisation signal transmitted by the first wireless communications device in response to the second type signal, and determining a duration of a time period between the time at which the second type signal is transmitted and a time at which the synchronisation signal, transmitted in response, is received.

Paragraph 43. A method according to paragraph 42, wherein the number of times is predetermined.

Paragraph 44. A method according to paragraph 42, the method comprising determining the number of times based on a received signal strength associated with the beacon signal.

Paragraph 45. A method according to paragraph 42 or paragraph 44, the method comprising determining the number of times based on an estimated accuracy of an estimate of the distance between the first and second wireless communications devices.

Paragraph

46. A wireless communications device comprising a transmitter configured to transmit first type signals and second type signals, a receiver configured to receive second type signals, and a controller configured to control the transmitter and the receiver so that the wireless communications device is operable: while operating in a first mode of operation, to transmit a first type signal as a beacon signal requesting another wireless communications device to transmit a second type signal, the first type signal being decodable by the other wireless communications device when the other wireless communications device is operating in the first mode of operation, after transmitting the first type signal, to operate in a second mode of operation in which the wireless communications device monitors for a second type signal transmitted by the other wireless communications device in response to the first type signal, to receive the second type signal, the second type signal being a first synchronisation signal, to determine a first time at which the second type signal is received, and in response to receiving the first synchronisation signal, to transmit at a second time a second synchronisation signal, wherein one or both of the wireless communications device and the other wireless communications device are able to determine the estimate of the distance between the wireless communications device and the other wireless communications device, the estimate of the distance based on a first duration and a second duration, the first duration being a time period between the first time and the second time and the second duration being a time period between a time of transmission by the other wireless communications device of the first synchronisation signal and a time of reception by the other wireless communications device of the final synchronisation signal.

Paragraph 47. Circuitry for a wireless communications device, the circuitry comprising transmitter circuitry configured to transmit first type signals and second type signals, receiver circuitry configured to receive second type signals, and controller circuitry configured to control the transmitter circuitry and the receiver circuitry so that the wireless communications device is operable: while operating in a first mode of operation, to transmit a first type signal as a beacon signal requesting another wireless communications device to transmit a second type signal, the first type signal being decodable by the other wireless communications device when the other wireless communications device is operating in the first mode of operation, after transmitting the first type signal, to operate in a second mode of operation in which the wireless communications device monitors for a second type signal transmitted by the other wireless communications device in response to the first type signal, to receive the second type signal, the second type signal being a first synchronisation signal, to determine a first time at which the second type signal is received, and in response to receiving the first synchronisation signal, to transmit at a second time a second synchronisation signal, wherein one or both of the wireless communications device and the other wireless communications device are able to determine the estimate of the distance between the wireless communications device and the other wireless communications device, the estimate of the distance based on a first duration and a second duration, the first duration being a time period between the first time and the second time and the second duration being a time period between a time of transmission by the other wireless communications device of the first synchronisation signal and a time of reception by the other wireless communications device of the final synchronisation signal.

Paragraph 48. A wireless communications device comprising a transmitter configured to transmit first type signals and second type signals, a receiver configured to receive second type signals, and a controller configured to control the transmitter and the receiver so that the wireless communications device is operable: while operating in a first mode of operation, to transmit a first type signal as a beacon signal requesting another wireless communications device to transmit a second type signal, the first type signal being decodable by the other wireless communications device when the other wireless communications device is operating in the first mode of operation, after transmitting the first type signal, to operate in a second mode of operation in which the wireless communications device monitors for a second type signal transmitted by the other wireless communications device in response to the first type signal, receiving the second type signal, the second type signal being a first synchronisation signal, determining a first time at which the second type signal is received, and repeating, a number of times, the steps of: in response to receiving the first or a further synchronisation signal, transmitting a synchronisation signal, and receiving a further synchronisation signal, in response to receiving a further synchronisation signal, transmitting at a second time a final synchronisation signal, wherein one or both of the wireless communications device and the other wireless communications device are able to determine the estimate of the distance between the wireless communications device and the other wireless communications device, the estimate of the distance based on a first duration and a second duration, the first duration being a time period between the first time and the second time and the second duration being a time period between a time of transmission by the other wireless communications device of the first synchronisation signal and a time of reception by the other wireless communications device of the final synchronisation signal.

Paragraph 49. Circuitry for a wireless communications device, the circuitry comprising transmitter circuitry configured to transmit first type signals and second type signals, receiver circuitry configured to receive second type signals, and controller circuitry configured to control the transmitter circuitry and the receiver circuitry so that the wireless communications device is operable: while operating in a first mode of operation, to transmit a first type signal as a beacon signal requesting another wireless communications device to transmit a second type signal, the first type signal being decodable by the other wireless communications device when the other wireless communications device is operating in the first mode of operation, after transmitting the first type signal, to operate in a second mode of operation in which the wireless communications device monitors for a second type signal transmitted by the other wireless communications device in response to the first type signal, receiving the second type signal, the second type signal being a first synchronisation signal, determining a first time at which the second type signal is received, and repeating, a number of times, the steps of: in response to receiving the first or a further synchronisation signal, transmitting a synchronisation signal, and receiving a further synchronisation signal, in response to receiving a further synchronisation signal, transmitting at a second time a final synchronisation signal, wherein one or both of the wireless communications device and the other wireless communications device are able to determine the estimate of the distance between the wireless communications device and the other wireless communications device, the estimate of the distance based on a first duration and a second duration, the first duration being a time period between the first time and the second time and the second duration being a time period between a time of transmission by the other wireless communications device of the first synchronisation signal and a time of reception by the other wireless communications device of the final synchronisation signal.

Paragraph 50. A wireless communications device comprising a transmitter configured to transmit second type signals, a receiver configured to receive first type signals and second type signals, and a controller configured to control the transmitter and the receiver so that the wireless communications device is operable: while operating in a first mode of operation, to receive a first type signal as a beacon signal requesting the wireless communications device to transmit a second type signal, the beacon signal transmitted by another wireless communications device, in response to receiving the beacon signal, to transmit the second type signal, the second type signal being a first synchronisation signal and indicating that the other communications device is to transmit a second synchronisation signal, to determine a first time at which the first synchronisation signal is transmitted, and to operate in a second mode of operation in which the wireless communications device monitors for a second type signal transmitted by the other wireless communications device in response to the first synchronisation signal, to receive a second synchronisation signal transmitted by the other device, and determining a second time at which the second synchronisation signal is received, wherein one or both of the wireless communications device and the other wireless communications device are able to determine the estimate of the distance between the wireless communications device and the other wireless communications device, the estimate of the distance based on a first duration and a second duration, the second duration being a time period between the first time and the second time, the first duration being a time period between a third time and a fourth time, the third time being a time at which the other wireless communications device received the first synchronisation signal and the fourth time being a time at which the other wireless communications device transmitted the second synchronisation signal.

Paragraph 51. Circuitry for a wireless communications device, the circuitry comprising transmitter circuitry configured to transmit second type signals, receiver circuitry configured to receive first type signals and second type signals, and controller circuitry configured to control the transmitter circuitry and the receiver circuitry so that the wireless communications device is operable:
s while operating in a first mode of operation, to receive a first type signal as a beacon signal requesting the wireless communications device to transmit a second type signal, the beacon signal transmitted by another wireless communications device, in response to receiving the beacon signal, to transmit the second type signal, the second type signal being a first synchronisation signal and indicating that the other communications device is to transmit a second synchronisation signal, to determine a first time at which the first synchronisation signal is transmitted, and to operate in a second mode of operation in which the wireless communications device monitors for a second type signal transmitted by the other wireless communications device in response to the first synchronisation signal, to receive a second synchronisation signal transmitted by the other device, and determining a second time at which the second synchronisation signal is received, wherein one or both of the wireless communications device and the other wireless communications device are able to determine the estimate of the distance between the wireless communications device and the other wireless communications device, the estimate of the distance based on a first duration and a second duration, the second duration being a time period between the first time and the second time, the first duration being a time period between a third time and a fourth time, the third time being a time at which the other wireless communications device received the first synchronisation signal and the fourth time being a time at which the other wireless communications device transmitted the second synchronisation signal.

Paragraph 52. A method according to any preceding paragraph wherein a power consumption of a wireless communications device when in the first mode of operation is lower than a power consumption of the wireless communications device when in the second mode of operation.

Paragraph 53. A method according to any preceding paragraph, wherein the first mode of operation is a radio resource control (RRC) idle mode.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] 3GPP TS 38.300 v. 15.2.0 “NR; NR and NG-RAN Overall Description; Stage 2 (Release 15)”, June 2018
[2] Holma H. and Toskala A, “LTE for UMTS OFDMA and SC-FDMA based radio access”, John Wiley and Sons, 2009
[3] “Indoor Positioning Algorithm Based on the Improved RSSI Distance Model”, Li et al., Sensors 2018, 18, available at https://www.mdpi.com/1424-8220/18/9/2820/pdf
[4] 3GPP TS 38.305 “3rd Generation Partnership Project; Technical Specification Group Radio Access Network; NG Radio Access Network (NG-RAN); Stage 2 functional specification of User Equipment (UE) positioning in NG-RAN (Release 16)”, version 16.1.0, July 2020
[5] International patent application PCT/EP2018/071659 published as WO 2019030337, 14 Feb. 2019

1. A method of operating a first wireless communications device for allowing one or both of the first wireless communications device and a second wireless communications device to determine an estimate of a distance between the first and second wireless communication devices, the method comprising
while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation,
after transmitting the first type signal, operating in a second mode of operation in which the first wireless communications device monitors for a second type signal transmitted by the second wireless communications device in response to the first type signal,
receiving the second type signal, the second type signal being a first synchronisation signal,
determining a first time at which the second type signal is received, and
in response to receiving the first synchronisation signal, the first wireless communications device transmitting at a second time a second synchronisation signal,
wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the second synchronisation signal.

2. A method according to claim 1, the method comprising
determining the estimate of the distance between the first and second wireless communication devices based on the first duration and the second duration.

3. A method according to claim 2, wherein determining the estimate of the distance between the first and second wireless communication devices based on the first duration and the second duration comprises receiving an indication of the estimate of the distance, the indication transmitted by the second wireless communications device.

4. A method according to claim 3, wherein the indication of the estimate of the distance is received from an infrastructure equipment of a wireless communications network.

5. A method according to claim 2, the method comprising
receiving by the first wireless communications device an indication of the second duration, the indication of the second duration being transmitted by the second wireless communications device.

6. A method according to claim 1, wherein the first duration is a predetermined duration.

7. A method according to claim 1, the method comprising
transmitting an indication of the first duration to the second wireless communications device.

8. A method according to claim 1, the method comprising
selecting one of a plurality of predetermined durations, and
before transmitting the second synchronisation signal, determining the second time based on the first time and the selected duration.

9. A method according to claim 1, wherein the beacon signal is transmitted at a power level, the method comprising
determining the power level based on an application to which the estimate of the distance is to be provided.

10. A method according to claim 1, wherein the first type signal is a Bluetooth Low Energy beacon signal.

11. A method according to claim 1, the method comprising
receiving, while in the first mode of operation, another first type signal transmitted as a beacon signal by the second wireless communications device, wherein
transmitting the first type signal as a beacon signal is in response to receiving the beacon signal transmitted by the second wireless communications device.

12. A method according to claim 11, the method comprising
determining a received power level associated with the other first type signal, wherein
transmitting the first type signal as a beacon signal is in response to determining that the received power level associated with the other first type signal is above a predetermined threshold.

13. A method according to claim 1, wherein the first wireless communications device is configured to transmit and receive signals on a wireless access interface provided by an infrastructure equipment of a wireless communications network, and the method comprises
receiving a signal having a same structure as the second type signal, the signal transmitted by the infrastructure equipment for allowing the first wireless communications device to synchronise with the infrastructure equipment or for determining a location of the first wireless communications device.

14. A method according to claim 13, wherein the signal transmitted by the infrastructure equipment is one of a primary synchronisation signal (PSS), a secondary synchronisation signal (SSS) or a positioning reference signal (PRS).

15. A method according to claim 1, wherein the first wireless communications device is configured to transmit and receive signals on a wireless access interface provided by an infrastructure equipment of a wireless communications network, and
the second type signal has a same structure as a random access preamble for transmission on a random access channel of the wireless access interface.

16. (canceled)

17. A method according to claim 1, wherein the beacon signal is selected from one of a plurality of beacon signal sequences.

18.-22. (canceled)

23. A method of operating a first wireless communications device for allowing one or both of the first wireless communications device and a second wireless communications device to determine an estimate of a distance between the first and second wireless communication devices, the method comprising
while operating in a first mode of operation, the first wireless communications device transmitting a first type signal as a beacon signal requesting the second wireless communications device to transmit a second type signal, the first type signal being decodable by the second wireless communications device when the second wireless communications device is operating in the first mode of operation,
after transmitting the first type signal, operating in a second mode of operation in which the first wireless communications device monitors for a second type signal transmitted by the second wireless communications device in response to the first type signal,
receiving the second type signal, the second type signal being a first synchronisation signal,
determining a first time at which the second type signal is received, and
repeating, a number of times, the steps of:
in response to receiving the first or a further synchronisation signal, transmitting a synchronisation signal, and
receiving a further synchronisation signal,
in response to receiving a further synchronisation signal, transmitting at a second time a final synchronisation signal,
wherein one or both of the first wireless communications device and the second wireless communications device are able to determine the estimate of the distance between the first and second wireless communications devices, the estimate of the distance based on a first duration and a second duration, the first duration being a time period between the first time and the second time and the second duration being a time period between a time of transmission by the second wireless communications device of the first synchronisation signal and a time of reception by the second wireless communications device of the final synchronisation signal.

24. A method according to claim 23, wherein the steps are repeated a predetermined number of times.

25. A method according to claim 23, wherein
in one repetition of the steps, receiving a further synchronisation signal comprises receiving an indication that no additional further synchronisation signal will be transmitted by the second wireless communications device.

26.-46. (canceled)

47. Circuitry for a wireless communications device, the circuitry comprising
transmitter circuitry configured to transmit first type signals and second type signals,
receiver circuitry configured to receive second type signals, and
controller circuitry configured to control the transmitter circuitry and the receiver circuitry so that the wireless communications device is operable:
while operating in a first mode of operation, to transmit a first type signal as a beacon signal requesting another wireless communications device to transmit a second type signal, the first type signal being decodable by the other wireless communications device when the other wireless communications device is operating in the first mode of operation,
after transmitting the first type signal, to operate in a second mode of operation in which the wireless communications device monitors for a second type signal transmitted by the other wireless communications device in response to the first type signal,
to receive the second type signal, the second type signal being a first synchronisation signal,
to determine a first time at which the second type signal is received, and
in response to receiving the first synchronisation signal, to transmit at a second time a second synchronisation signal,
wherein one or both of the wireless communications device and the other wireless communications device are able to determine the estimate of the distance between the wireless communications device and the other wireless communications device, the estimate of the distance based on a first duration and a second duration, the first duration being a time period between the first time and the second time and the second duration being a time period between a time of transmission by the other wireless communications device of the first synchronisation signal and a time of reception by the other wireless communications device of the final synchronisation signal.

48.-53. (canceled)
